(19) United States
(12) Patent Application Publication
(10) Pub. No.: US 2024/0195794 A1
(43) Pub. Date: Jun. 13, 2024

(54) MANAGEMENT METHOD FOR THE RENEWAL OF AUTHENTICATION CERTIFICATES OF CONNECTED COMPONENTS

(71) Applicant: MANITOWOC CRANE GROUP FRANCE, DARDILLY (FR)

(72) Inventor: Nicolas LARMONIER, LYON (FR)

(21) Appl. No.: 18/537,405

(22) Filed: Dec. 12, 2023

(30) Foreign Application Priority Data
Dec. 12, 2022 (FR) 2213188

(51) Int. Cl. H04L 9/40

(52) U.S. Cl. CPC H04L 63/0823

(57) ABSTRACT

A method for managing a renewal of an authentication certificate of a connected component, which is valid for a validity period implements a renewal phase during which the connected component is connected to a remote certificate renewal server which then verifies the validity of the authentication certificate. If the authentication certificate is still valid, the remote certificate renewal server renews it automatically. If not, that is to say if the validity period has been exceeded, the renewal is carried out manually by a control operator from a remote database to which the remote renewal server certificate transmits: the identifier of the connected component wanting to renew its authentication certificate, and the certification renewal request of said connected component.

### FIELD

The present disclosure relates to a management method for renewing authentication certificates of connected components.

The present disclosure relates more particularly to a management method making it possible to renew an authentication certificate of a connected component when said authentication certificate has exceeded its validity date.

The present disclosure finds a non-limiting application in the renewal of authentication certificates of connected components of a construction machine, for example a crane, but can be extended to any system having an authentication certificate used within a given application context.

### BACKGROUND

By definition, an authentication certificate is comparable to a certificate or identity card used by an entity (which may be a person or a system) to be identified to a computer server in order to access data and/or applications that contain said computer server, to download updates, etc. The authentication certificate is therefore a security means to prevent an unauthorized entity from accessing the content of the server, this entity potentially being malicious (for example, by being willing to steal the data contained in the server).

The certificates issued to entities have a validity period which generally lasts one year. This is why the entity, in the event that it wishes to continue to benefit from the services offered by the computer system for which the authentication certificate is required, must renew its authentication certificate during a renewal period comprised in the validity period (for example, if the authentication certificate is valid for one year, the twelfth month). If renewed, the certificate is then valid again for a new validity period. The renewal can be carried out either by the instance that generated then delivered the authentication certificate to the entity, or by a different instance.

In the application context of construction sites, authentication certificates can be assigned to connected components of a construction machine, for example a crane, so that they are connected to a remote IT infrastructure, for example a remote update manager server to download updates relating to their operation.

However, after being used on a construction site, a crane (or generally a construction machine) may remain stored and unpowered for several months, such that its connected components are no longer able to be connected. Also, when it is operated and powered again, the authentication certificates of the connected components may possibly have expired, so that when they restart and if they attempt to be connected to the remote IT infrastructure to be updated, access to updates is denied to them by the remote IT infrastructure.

The document US 2011/113239 discloses a method for renewing component authentication certificates, whether or not their renewal deadline has passed. The method of that document is implemented by a certificate manager comprising remote infrastructures configured to: generate and assign authentication certificates to the components; check whether, when a request for renewal of a certificate is issued, the expiry date of said certificate has not passed; renew authentication certificates that are still valid or expired. Such remote infrastructures have the disadvantage of being vulnerable to external attacks and intrusion attempts, implying a potential risk of recovery of sensitive data, relating to the authentication certificates or their associated components, by malicious entities.

### SUMMARY

The present disclosure aims to solve such a problem, by providing a solution which makes it possible to renew an expired authentication certificate, following a temporary disconnection, while maintaining a high security level.

The present disclosure relates to a method for managing a renewal of an authentication certificate uniquely assigned to a connected component, in which said authentication certificate is valid for a validity period until an expiration date and is expired beyond the expiration date, said authentication certificate serving as a means of authenticating the connected component to a remote update manager server as long as said authentication certificate is valid, the method implementing a renewal phase comprising at least the following successive steps:
a remote connection step during which the connected component is connected to a remote certificate renewal server for a new validity period,
a renewal request step during which the connected component issues a certification renewal request to the remote certificate renewal server,
a checking step during which the remote certificate renewal server checks whether the authentication certificate is valid or expired;

and wherein if the authentication certificate is valid at the checking step, then the remote certificate renewal server automatically renews the authentication certificate for a new validity period;

on the contrary, if the authentication certificate has expired at the checking step, then:
the remote certificate renewal server transmits to a remote database an identifier of the connected component associated with its certification renewal request,
the identifier of the connected component and its certification renewal request are manually controlled by a control operator having access to the remote database;
the authentication certificate is renewed or not for the new validity period by the control operator depending on its manual control;
   the method implementing, before the renewal phase, a certification phase during which the connected component is physically connected to a local server, and said local server generates, signs, then assigns the authentication certificate to said connected component.

Thus, the present disclosure resolves the problem previously exposed, by making it possible to renew the authentication certificate of a connected component whether or not its validity period has been exceeded; which authentication certificate is used by the connected component to be identified to a remote update manager server and to download updates. In order to renew its authentication certificate, the connected component is connected to a remote certificate renewal server and issues a certification renewal request to it, which remote certificate renewal server then checks whether the authentication certificate is still valid or not.

According to a possibility, the renewal phase may comprise a security step during which the remote certificate renewal server checks an identifier of the connected component and/or that the connected component has the authentication certificate, before the renewal request step.

In other words, prior to this renewal request step, a security step can be implemented to avoid any access attempt by a malicious entity during which the remote certificate renewal server:
controls an identifier of the connected component, by checking for example if it is included in a list of identifiers of connected components that must be known to said remote certificate renewal server. Thus, a connected component which has an authentication certificate but whose identifier is unknown to said remote certificate renewal server cannot issue an authentication certificate renewal request, or continue to communicate more generally with the remote certificate renewal server. Indeed, the connected component can potentially be malicious and have a falsified authentication certificate produced by fraudsters who may have had illegal access to the certificate format; and/or
controls whether or not the connected component has an authentication certificate.

Thus, a connected component that must be known to the remote certificate renewal server but does not have an authentication certificate cannot issue a certification renewal request.

In the case where the renewal request is made by the connected component for an authentication certificate that is still valid, the renewal is automatically carried out by the remote certificate renewal server.

Otherwise, and as indicated above, the remote certificate renewal server transmits to a remote database, the identifier of the connected component seeking to renew its authentication certificate associated with its renewal request, which are controlled by a control operator (a natural person) having access to the remote database. Thus, in this context, the certification renewal is carried out manually by the control operator.

In order that manual certification renewal to be carried out quickly, it is possible for the remote certificate renewal server to alert the control operator, for example by sending an automatic email to the control operator's email address simultaneously with the transmission into the remote database of the identifier of the connected component and its certification renewal request.

In a variant according to the present disclosure, the certification renewal request cannot be made before having reached a predefined renewal period which is located at the end of the validity period. In other words, if the connected component is connected to the remote certificate renewal server and issues its certification renewal request too early, therefore before the renewal period begins, the certification renewal is not accepted.

If the certification renewal is carried out remotely, the generation, allocation and signing of an authentication certificate are done locally, using the local server installed for example in a production factory. Thus, the local server acts as a certification authority. More precisely, the authentication certificates are generated, signed, and assigned to connected components after manufacturing and once programmed to carry out the tasks for which they are intended. In order to receive their authentication certificate, the connected components are physically connected to the local server, for example by means of an Ethernet cable.

Advantageously, the use of a local server makes it possible to limit the risks of remote malicious intrusion and data leakage, whether relating to: the programming and operation of connected components; or certificates. The local generation and allocation of authentication certificates makes it possible, by extension, to reduce the risk of attempted intrusion on the remote certificate renewal server.

According to a characteristic of the present disclosure, the authentication certificate contains an identifier of the local server.

In other words, if the method relies on several local servers, each local server will generate authentication certificates in which its identifier (also called server identifier) will be contained. Advantageously, this allows a control operator to be able to easily and quickly trace and identify all the certificates which may have been generated and assigned by a given local server/certification authority.

In another variant, it is the format of the authentication certifications which makes it possible to determine the local server(s) which generated them.

According to a characteristic of the present disclosure, before accessing the remote update manager server, the connected component is connected to a remote provisioning server which contains a list of identifiers of several local servers authorized to generate and sign authentication certificates; and in which said remote provisioning server controls the validity of the authentication certificate of the connected component before giving it access to the remote update manager server.

Advantageously, the remote provisioning server makes it possible to reinforce security for the access to the remote update manager server, and thus minimize the risks of intrusion by a malicious entity, by controlling whether the authentication certificate that the connected component wishing to be connected to the remote update manager server contains an identifier comprised in a list of identifiers of several authorized/known local servers.

In a variant according to the present disclosure, the remote certificate renewal server controls, during the security step for the certification renewal request, whether the authentication certificate possessed by the connected component contains the identifier of the local server having issued it, and similarly to the remote provisioning service, if the identifier is contained in the list of identifiers of several authorized local servers (therefore meaning that the two servers share the same list). Depending on the result of this control, the connected component may or may not issue a certification renewal request.

According to a characteristic of the present disclosure, the control of the authentication certificate validity of the connected component by the remote provisioning server comprises a control of the identifier of the local server contained in the authentication certificate, and if said local server is classified as a revoked server, then the remote provisioning server prohibits the access to the remote update manager server for said connected component.

In other words, the generation of an authentication certificate comprising the identifier of the certification authority (here the local server) which generated it advantageously allows the remote provisioning server to easily and quickly revoke all the authentication certificates generated by one or more particular local servers without revoking those generated and assigned by others. These revocations may, for example, originate from an observation by operators on these particular local servers of data leakages. It is then no longer possible for connected components whose authentication certificate has been revoked to access the services of the remote update manager server.

In an embodiment according to the present disclosure, the operator has the possibility of canceling the revocation of a revoked local server. Following this cancellation of revocation, the authentication certificates produced by this local server become valid again. In the case where the revocation of an authentication certificate would have taken place before the connected component can download an update from the remote update manager server, and the revocation cancellation is carried out after expiration of the validity period of the authentication certificate, then the connected component must renew the latter following the steps of the method previously described (ultimately, the renewal of certification will therefore be carried out manually by the control operator).

According to an embodiment of the present disclosure, the connected component is a component of a construction machine, for example a crane.

According to an embodiment of the present disclosure, the certificate renewal server, the remote database, the remote provisioning service, and the remote update manager system are comprised in a remote IT infrastructure.

According to an embodiment of the present disclosure, the remote infrastructure is a «cloud» infrastructure.

### BRIEF DESCRIPTION OF THE DRAWINGS

Other characteristics and advantages of the present invention will appear on reading the detailed description below, of a non-limiting implementation example, made with reference to the appended figures in which:

FIG. 1 is a schematic view showing examples of all the entities involved in the implementation of the method, and steps implemented during the certification phase during which the connected component is physically connected to a certification authority, which is a local server, to receive an authentication certification signed and valid throughout the validity period;

FIG. 2 is a schematic view of the method similar to that of FIG. 1, in which the steps implemented during the authentication certificate renewal phase are illustrated, when the connected component is connected to the remote certificate renewal server, and in the event that the validity period has not finished;

FIG. 3 is a schematic view of the method similar to those of FIG. 1 and FIG. 2, in which the steps implemented during the authentication certificate renewal phase are illustrated, when the connected component is connected to the remote certificate renewal server, and in the event that the validity period of the authenticity certificate has expired; and

FIG. 4 is a schematic view of the method similar to those of FIG. 1 to FIG. 3, in which the steps implemented when the connected component wants to be connected to the remote update manager server to download updates are illustrated.

### DESCRIPTION

The proposed method P makes it possible to renew the authentication certificates 1 of connected components 2, whether or not their validity period has exceeded.

According to an embodiment of the present disclosure, the connected components 2 are connected components of a construction machine, for example a crane 10, each using an authentication certificate 1 to be authenticated with a remote update manager server 3 in order to download updates relating, for example, to new features.

Prior to the renewal phase, the method P implements a certification phase during which the connected component 2 is connected to a certification authority which will generate, sign and deliver to the connected component 2 its authentication certificate 1.

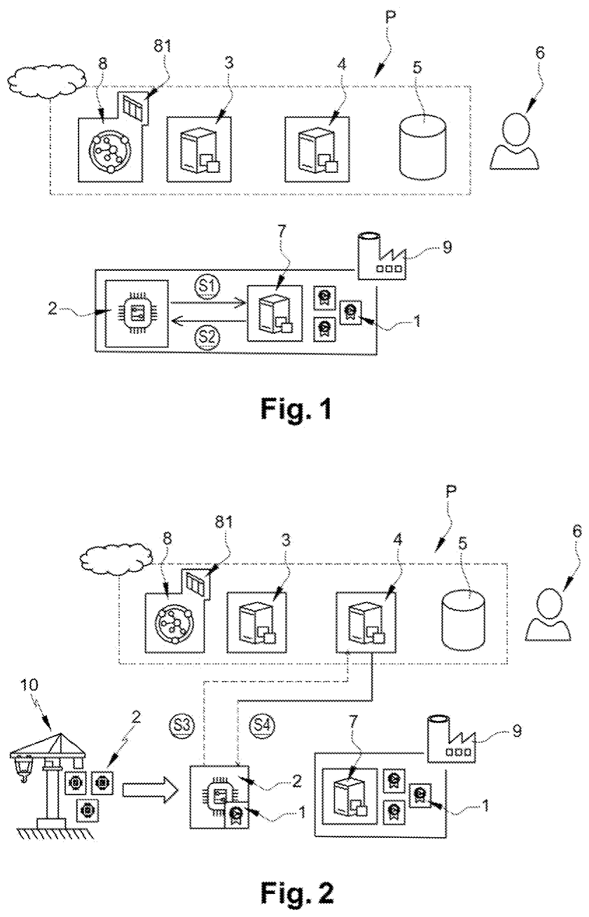

While the renewal phase is carried out with the connected component 2 being connected to a remote IT infrastructure, which is a remote certificate renewal server 4, the certification phase is implemented locally. With reference to FIG. 1, it may be a local server 7 installed in a production factory 9 in which the connected components are manufactured then programmed to ensure their functions. During a connection step S1, the connected component 2, once manufactured and programmed, is physically connected (by means of an Ethernet cable for example) and communicates with the local server 7, which generates, signs, and transmits during a transmission step S2 to the connected component 2, the authentication certificate 1 which has a validity period.

As explained previously, the use of a local server 7 makes it possible to limit the risks of remote malicious intrusion and data leakage, whether relating to: the programming and operation of connected components 2; and/or the authentication certificates. By extension, the local generation and allocation of authentication certificates 1 makes it possible to reduce the risk of attempted intrusion on the remote certificate renewal server 4 and/or the remote update manager server 3.

In a first variant according to the present disclosure, the authentication certificates 1 generated by a local server 7 contain its server identifier. Thanks to this, a natural person and/or an IT infrastructure can easily and quickly trace all the connected components having an authentication certificate generated and signed by this local server 7.

In a second variant, the distinction between authentication certificates 1 which are generated by different local servers 7 is based on their format. In other words, each local server 7 produces authentication certificates 1 according to a given format.

In a third variant, all the authentication certificates 1 are generated according to the same format. On the contrary, the arrangement and/or the nature of the data contained in the authentication certificate 1 (such as the expiration date of the certificate, the signature of the local server, the public key for data encryption, etc.) may differ depending on the local server 7 that generated it.

The connected component is programmed, following a power-up, to be connected to the remote update manager server 3 to download updates, and to the remote certificate renewal server 4 in order to renew its authentication certificate 1.

Given that a renewal of the authentication certificate 1 at a date/period relatively close to its generation would be of little use, the certification renewal request in an embodiment according to the present disclosure cannot be made before either reached a predefined renewal period, which is the expiration date of the authentication certificate 1. For example, if the validity period of the authentication certificate is one year, the renewal period can correspond to the last month of the validity period (namely the twelfth month).

In other words, if the connected component is connected to the remote certificate renewal server 4 and issues its certification renewal request too early, therefore before the start of the renewal period, the certification renewal is not carried out.

In an embodiment according to the present disclosure, the connected component 2 is programmed to determine whether it is powered on when the start date of the renewal period has exceeded, then if this is the case to be automatically connected to the remote certificate renewal server 4.

With reference to FIG. 2, the connected component 2 is connected during a connection step S3 to the remote certificate renewal server 4.

In an embodiment according to the present disclosure, it is possible that after connection of the connected component 2 a security step is implemented to avoid any access attempt by a malicious entity, during which the remote renewal server certificate 4 checks:
if the connected component 2 holds an authentication certificate 1, otherwise it cannot issue a renewal request; and
the authenticity of said authentication certificate 1.

In different variants according to the present disclosure, the remote certificate renewal server 4 can check: whether the authentication certificate 1 contains the identifier of the local server 7 that generated it, and whether this identifier is known or not; and/or the format of the authentication certificate 1; and/or the arrangement and/or nature of the data comprised in the authentication certificate 1.

It is also possible that the remote certificate renewal server 4 can also control a reference/an identifier of the connected component 2, by comparing it for example with a list listing all the references of all the connected components belonging to the entity (for example a crane manufacturer 10) implementing the method P. Thus, a connected component 2 which has an authentication certificate 1 but whose reference is unknown to the remote certificate renewal server 4 cannot issue a renewal request.

Following the connection step S3, and possibly the optional security step, the connected component 2 issues its certification renewal request for a new validity period (which may be of the same duration or of a different duration than the initial validity period according to different embodiments).

The remote certificate renewal server 4 then checks during a checking step whether the authentication certificate 1 of the connected component is still valid or not, that is to say if the validity period is not reaching the expiration date. As explained previously, a connected component 2 of a crane 10 may not be used and powered for long periods (sometimes several months) if it does not meet the progress needs of a construction site in progress. If the connected component 2 is turned back on after the start date of the renewal period has exceeded, it will be connected to the remote certificate renewal server 4, whether the validity period of the authentication certificate 1 is or not come to an end.

In the case where the certification renewal request is issued during the renewal period, the remote certificate renewal server 4 automatically renews the authentication certificate 1 during an automatic renewal step S4 (FIG. 2).

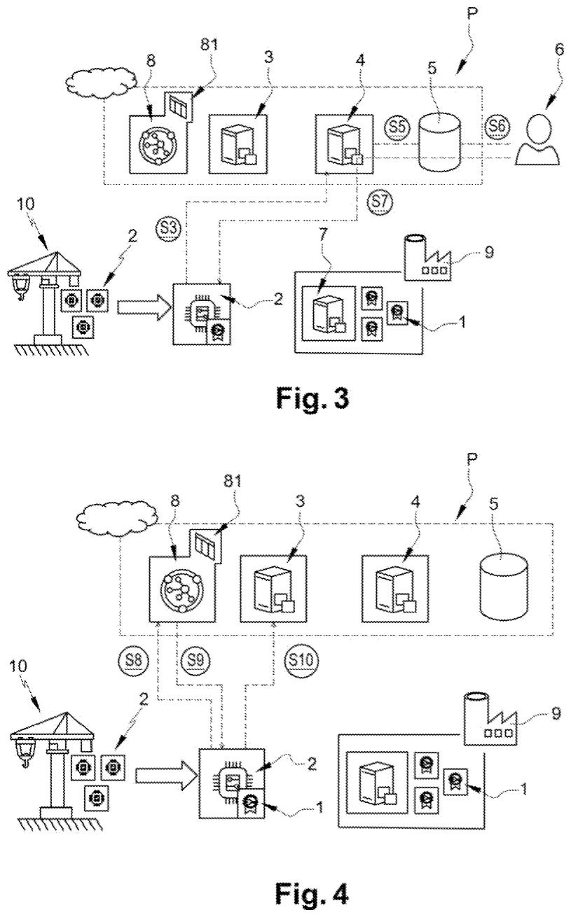

If the certification renewal request is issued after expiry of the validity period, with reference to FIG. 3, the remote certificate renewal server 4 transmits it during a transmission step S5 to a remote database 5. It transmits also to the remote database 5 a reference/an identifier of the connected component 2.

Following this transmission step S5, a control operator 6 having access to the remote database 5 controls, during a control step S6, the identifier of the connected component 2 and its certification renewal request. The control operator 6 is a natural person.

If the identifier of the connected component 2 is known and the certification renewal request is valid, the control operator 6 manually renews the validity period of the authentication certificate 1 during a manual renewal step S7. In a first embodiment according to the present disclosure, the manual renewal is carried out from the remote database 5, and the remote renewal server, in communication with it, takes note of said manual renewal. In a second embodiment according to the present disclosure, the control operator 6 is directly connected to the remote certificate renewal server 4 to carry out the manual renewal.

In order that the manual certification renewal is carried out quickly, it is possible for the remote certificate renewal server 4 to alert the control operator 6, for example by sending an automatic email to the email address of the control operator 6 simultaneously with the transmission of the identifier of the connected component 2 and its certification renewal request in the remote database 5.

When it has a valid authentication certificate 1, the connected component 2 can, as previously indicated, be connected to the remote update manager server 3.

With reference to FIG. 4, in the described embodiment, before accessing the remote update manager server 3, the connected component 2, during a connection step S8, is connected to a remote provisioning server 8 which contains a list of identifiers 81 of several local servers 7 authorized to generate and sign authentication certificates 1.

Thus, the remote provisioning server 8 makes it possible to reinforce the security for the access to the remote update manager server 3, and thus minimize the risks of intrusion by a malicious entity, by controlling whether the authentication certificate 1 that the connected component 2 possesses wishing to be connected to the remote update manager server 3 contains a local server identifier 7 comprised or not in the list of identifiers 81.

Note that this list of identifiers 81 can also be used by the remote certificate renewal server 4 in the embodiment where the security step is implemented and that the control of the authenticity of the authentication certification is based on a control of the identifier of the local server 7 which generated and delivered it.

The remote provisioning server 8, if it recognizes the identifier of the local server 7, authorizes the connected component 2 to be connected to the remote update manager server 3 during a connection authorization confirmation step S9.

The connected component 2 can then, during a connection step S10, be connected to the remote update manager server 3.

In the event of malicious intrusion and/or data leakage directly or indirectly affecting a local server 7, the provisioning server 8 has the capacity to revoke all the authentication certificates 1 generated and signed by it without impacting those generated by one or more other local servers 7. This also means that the provisioning server 8 can also carry out mass revocations if several local servers are impacted 7 by attacks.

The connected components 2 having a revoked authentication certificate 1 can no longer access the services of the remote update manager server 3, nor the remote certificate renewal server 4 for a renewal of the authentication certificate.

It is expected that the revocation of a local server 7 can be canceled by a control operator 6. Following this cancellation, the authentication certificates 1 produced by this local server 7 then become valid again. In the case where the cancellation of revocation takes place after expiration of the validity period of an authentication certificate 1, the connected component 2 possessing it is connected to the remote certificate renewal server 4 and waits for it to be 1 renewed manually.

Referring to FIG. 1 to FIG. 4, in the presented embodiments, the certificate renewal server 4, the remote database 5, the remote provisioning service 8, and the remote update manager system 3 are all cloud infrastructures.

1-5. (canceled)

6. A method for managing a renewal of an authentication certificate uniquely assigned to a connected component, in which said authentication certificate is valid for a validity period until an expiration date and is expired beyond the expiration date, said authentication certificate serving as a means of authenticating the connected component to a remote update manager server as long as said authentication certificate is valid, the method implementing a renewal phase comprising at least the following successive steps:
a remote connection step during which the connected component is connected to a remote certificate renewal server,
a renewal request step during which the connected component issues a certification renewal request to the remote certificate renewal server for a new validity period, and
a checking step during which the remote certificate renewal server checks whether the authentication certificate is valid or expired;
and wherein if the authentication certificate is valid at the checking step, then the remote certificate renewal server automatically renews the authentication certificate for the new validity period;
otherwise, if the authentication certificate has expired at the checking step, then:
the remote certificate renewal server transmits to a remote database an identifier of the connected component associated with its certification renewal request,
the identifier of the connected component and its certification renewal request are manually controlled by a control operator having access to the remote database; and
the authentication certificate is renewed or not for the new validity period by the control operator depending on its manual control;
the method implementing, before the renewal phase, a certification phase during which the connected component is physically connected to a local server, and said local server generates, signs, then assigns the authentication certificate to said connected component.

7. The method according to claim 6, wherein the authentication certificate contains an identifier of the local server.

8. The method according to claim 7, wherein, before accessing the remote update manager server, the connected component is connected to a remote provisioning server which contains a list of identifiers of several local servers authorized to generate and sign authentication certificates; and in which said remote provisioning server controls the validity of the authentication certificate of the connected component before giving it access to the remote update manager server.

9. The method according to claim 8, wherein the control of the validity of the authentication certificate of the connected component by the remote provisioning server comprises a control of the identifier of the local server contained in the authentication certificate, and if said local server is classified as a revoked server, then the remote provisioning server prohibits access to the remote update manager server for said connected component.

10. The method according to claim 6, wherein the connected component is a component of a construction machine

11. The method according to claim 10, wherein the construction machine is a crane.
